(19) United States
(12) Patent Application Publication
(10) Pub. No.: US 2025/0383034 A1
(43) Pub. Date: Dec. 18, 2025

(54) DIRECT BOND TEXTILE THERMOPLASTIC TECHNOLOGY

(71) Applicant: Danfoss A/S, Nordborg (DK)

(72) Inventors: Keith A. Swearingen, Toledo, OH (US); Aaron David Clark, Lambertville, MI (US)

(21) Appl. No.: 18/876,058

(22) PCT Filed: Jun. 28, 2023
(86) PCT No.: PCT/IB2023/056708

§ 371 Date: Dec. 17, 2024

Related U.S. Application Data
(60) Provisional application No. 63/356,411, filed on Jun. 28, 2022.

(51) Int. Cl. F16L 11/08; B29C 48/00; B29C 48/10; B29K 23/00; B29K 75/00; B29K 77/00; B29K 267/00; B32B 1/08; B32B 5/02; B32B 7/12; B32B 27/12; B32B 27/32; B32B 27/34; B32B 27/40; D04C 1/02; D04C 1/06

(52) U.S. Cl. CPC F16L 11/08; B29C 48/0021; B29C 48/10; B32B 1/08; B32B 5/02; B32B 7/12; B32B 27/12; B32B 27/32; B32B 27/34; B32B 27/40; D04C 1/02; D04C 1/06; B29K 2023/08; B29K 2075/00; B29K 2077/00; B29K 2267/00; B32B 2262/0276; B32B 2262/16; B32B 2274/00; B32B 2597/00; D10B 2331/04; D10B 2505/02

(57) ABSTRACT

Improved reinforced thermoplastic hoses exhibiting improved layer adhesion, improved burst pressure response, and better fitting retention are provided. High quality adhesion between tube, cover, and reinforcement layers is exhibited. Improved methods of making reinforced thermoplastic hoses to reduce use of SVHC chemicals and improve manufacturing efficiency are also provided. The thermoplastic hoses are suitable for pneumatic and hydraulic applications.

### CROSS-REFERENCE TO RELATED APPLICATION

This application is being filed on Jun. 27, 2023, as a PCT International Patent Application and claims the benefit of U.S. Patent Application Ser. No. 63/356,411, filed on Jun. 28, 2022, the disclosure of which is incorporated herein by reference in its entirety.

### BACKGROUND

Currently available reinforced thermoplastic hoses utilizing textile reinforcement may exhibit spotty layer adhesion resulting in inconsistent hose performance, for example, due to fitting retention issues and variable burst pressure response. Current methods of making reinforced hoses may employ Substance of Very High Concern (SVHC) adhesive chemicals such as isocyanate gas and N-methyl-2-pyrrolidone, alongside a subjective “tacking” step that takes from 6-10 hours to complete.

Improved reinforced thermoplastic hoses exhibiting improved layer adhesion, improved burst pressure response, and better fitting retention are desirable. In particular, thermoplastic hoses exhibiting high quality adhesion between tube, cover, and reinforcement layers are desirable. Improved methods of making reinforced thermoplastic hoses to reduce use of SVHC chemicals and improve manufacturing efficiency by eliminating a subjective and messy processing step are also desirable.

### SUMMARY

Improved reinforced thermoplastic hoses exhibiting improved layer adhesion, improved burst pressure response, and better fitting retention are provided. High quality adhesion between tube, cover, and reinforcement layers is exhibited by employing pretreated yarns comprising a reactive adhesive coating optionally with a thermoplastic elastomer comprising a reactive blend. Improved methods of making reinforced thermoplastic hoses to reduce use of SVHC chemicals and improve manufacturing efficiency are also provided. The thermoplastic hoses are suitable for pneumatic and hydraulic applications.

A thermoplastic hose is provided comprising a multiplicity of layers including a first textile braid reinforcement layer covalently bound to an inner tube layer comprising a first thermoplastic elastomer, and an outer cover layer comprising a second thermoplastic elastomer. In some examples, the adhesive strength between the inner tube layer and the textile braid reinforcement layer is at least 8 lbf, at least 10 lbf, or at least 15 lbf, when tested according to ASTM D413 Type B, 90° peel. The thermoplastic hose comprises an inner tube layer directly bonded to the textile reinforcement layer without an intervening adhesive layer. The thermoplastic hose comprises an outer cover layer directly bonded to the textile reinforcement layer without an intervening adhesive layer.

The first textile braid reinforcement layer may comprise a pretreated yarn selected from the group consisting of polyester, aramid, nylon, cotton, and rayon pretreated yarns. The pretreated yarn may comprise a reactive adhesive coating capable of forming covalent bonds to the first thermoplastic elastomer. The pretreated yarn may comprise an immobilized isocyanate, resorcinol formaldehyde (RF), or phenol resorcinol formaldehyde (PRF) reactive adhesive coating. The pretreated yarn may be an isocyanate pretreated polyester yarn. The first pretreated yarn may comprise a polyester, aramid, nylon, cotton, or rayon yarn pretreated with a reactive adhesive coating capable of forming covalent bonds to a first thermoplastic elastomer in the first thermoplastic elastomer composition. In some cases, the first pretreated yarn comprises an immobilized isocyanate, resorcinol formaldehyde (RF), or phenol resorcinol formaldehyde (PRF) reactive adhesive coating.

The inner tube layer can comprise a first thermoplastic elastomer, for example, selected from the group consisting of polyamide, thermoplastic polyurethane, thermoplastic polyester elastomer, copolyester, acrylic copolymer, polyolefin blend, and polyolefin alloy, optionally wherein the first thermoplastic elastomer is a polyamide or a thermoplastic polyurethane. The first thermoplastic elastomer may be a polyamide, such as a PA6, PA 12, PA 6,6, or PA 6,12. The first thermoplastic elastomer may be a thermoplastic polyether polyurethane. The inner tube layer may further comprise a maleic anhydride grafted copolymer. The maleic anhydride grafted copolymer may be selected from the group consisting of maleic anhydride grafted ethylene-butyl acrylate copolymer and maleic anhydride grafted plastomer (ethylene alpha olefin copolymer).

In some examples, the inner tube layer may comprise 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomers in the inner tube layer.

The outer cover layer may comprise a second thermoplastic elastomer, for example, selected from the group consisting of polyamide, thermoplastic polyurethane, thermoplastic polyester elastomer, copolyester, acrylic copolymer, polyolefin blend, and polyolefin alloy, optionally wherein the second thermoplastic elastomer is a polyamide or a thermoplastic polyurethane.

The outer cover layer may comprise a reactive blend comprising a maleic anhydride grafted thermoplastic copolymer. The maleic anhydride grafted copolymer may be selected from the group consisting of maleic anhydride grafted ethylene-butyl acrylate copolymer and maleic anhydride grafted plastomer (ethylene alpha olefin copolymer). In some examples, the outer cover layer may comprise 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomer in the outer cover layer.

In some examples, the first thermoplastic elastomer and the second thermoplastic elastomer are different. In some examples, the first thermoplastic elastomer and the second thermoplastic elastomer are the same.

The inner tube layer may include a polyamide. The polyamide may be polyamide 6. The polyamide may be polyamide 12. The outer cover layer may include a polyamide. The outer cover layer may include a thermoplastic polyurethane.

In some examples, the thermoplastic hose further comprises a second textile braid layer covalently bound to the outer cover layer.

A thermoplastic hose is provided, comprising in the direction from the interior to the exterior surface of the hose an inner tube layer comprising a first thermoplastic elastomer covalently bound to a first textile braid reinforcement layer; and a second textile braid layer covalently bound to an outer cover layer comprising a second thermoplastic elastomer. The first and second textile reinforcement layers may be covalently bound.

A thermoplastic hose is provided, comprising in the direction from the interior to the exterior surface of the hose an inner tube layer comprising a first thermoplastic elastomer covalently bound to a textile braid reinforcement layer; and an outer cover layer comprising a second thermoplastic elastomer. In some examples, the textile braid reinforcement layer is covalently bound to the outer cover layer.

A method of making a thermoplastic hose is provided, comprising extruding a first thermoplastic elastomer composition over a mandrel to form the inner tube layer; braiding a first pretreated yarn over the inner tube layer to form a first textile braid reinforcement layer; heating the first textile braid reinforcement layer to a temperature >100° C. to form a covalent bond between the pretreated yarn and the first thermoplastic elastomer to form a covalently bonded first textile braid reinforcement layer; and extruding a second thermoplastic elastomer composition over the covalently bonded first textile braid reinforcement layer to form the cover layer, heating to a temperature >100° C., and cooling to form the thermoplastic hose. In some examples, the method further comprises braiding a second pretreated yarn over the reinforced inner tube layer prior to the second extruding step. The method can further comprise expelling the hose from the mandrel. The method provides a thermoplastic hose comprising an inner tube layer directly bonded to the textile reinforcement layer without a step of applying an intervening adhesive layer. The method provides a thermoplastic hose comprises an outer cover layer directly bonded to the textile reinforcement layer without a step of applying an intervening adhesive layer.

### BRIEF DESCRIPTION OF THE DRAWINGS

FIG. 1 illustrates an exemplary thermoplastic hose 100 according to the present disclosure comprising a multiplicity of layers including an inner tube layer 102, a reinforcement layer 106, and an outer cover layer 110.

FIG. 2 illustrates an exemplary thermoplastic hose 200 according to the present disclosure comprising a multiplicity of layers including an inner tube layer 102, a first reinforcement layer 106, a second reinforcement layer 108, and an outer cover layer 110.

FIG. 3 illustrates two exemplary direct bond textile thermoplastic elastomer adhesion reactions. The upper panel illustrates a cartoon of a diisocyanate treated textile fabric in a poly condensation reaction to a polyamide 6 layer, such as a tube or cover layer, to form a representative adhesive urea linkage. The lower panel illustrates a cartoon of a resorcinol formaldehyde treated textile in a polycondensation reaction with a polyamide 6 layer, such as a tube or cover layer, to form a representative covalent linkage via amino terminus, and with additional hydrogen bonding.

### DETAILED DESCRIPTION

Methods of making reinforced multi-layer thermoplastic hoses are provided utilizing RFL-pretreated or isocyanate-pretreated yarns capable of reacting synergistically with reactive chemistry formulated into thermoplastic polyurethane (TPU) and nylon resins to achieve improved, quality adhesion between the layers of thermoplastic hoses. Thermoplastic hoses exhibiting high quality adhesion between tube, cover, and reinforcement layers are provided. Improved product consistency is exhibited, which is due, at least in part, to elimination of a subjective and messy processing step in the hose production process. Removal of SVHC chemicals isocyanate gas and methyl pyrrolidone in the hose production process is another advantage.

The thermoplastic hoses according to the disclosure are suitable for pneumatic or hydraulic applications, for example, for use in lifts, cranes, material handling, lubrication, and airbrake hose. The hydraulic fluid may be selected from, for example, a hydrocarbon oil, a poly alkeneglycol (PAG), or a polyolester (POE) oil.

The singular forms “a”, “an” and “the” are intended to include the plural forms as well, unless the context clearly indicates otherwise.

The term “and/or” refers to and encompasses any and all possible combinations of one or more of the associated listed items.

The term “about,” when referring to a measurable value such as an amount of a compound, time, temperature, and the like, is meant to encompass variations of 10%, 5%, 1%, 0.5%, or even 0.1% of the specified amount.

Unless otherwise specified, the term “percent” or “%” refers to weight percent.

As used herein, the term “composition” may refer to one or more of a compound, mixture, blend, alloy, polymer, and/or copolymer.

The term “room temperature” refers to a temperature in the range of 20 to 25° C., with an average of 23° C.

As provide herein, ranges are intended to include, at least, the numbers defining the bounds of the range.

All patents, patent applications and publications referred to herein are incorporated by reference in their entirety.

### Hose Arrangements

The disclosure provides a thermoplastic hose comprising a multiplicity of layers. For example, the hose may include a tube layer, a reinforcement layer and a cover layer. In some examples, the hose may include a treated textile reinforcement layer covalently bonded to an inner thermoplastic tube layer and a thermoplastic outer cover layer. The thermoplastic hose according to the present disclosure may comprise three or more layers. The thermoplastic hose according to the present disclosure may comprise one or more, or two or more textile braid reinforcement layers. The textile braid reinforcement layers may be intermediate layers.

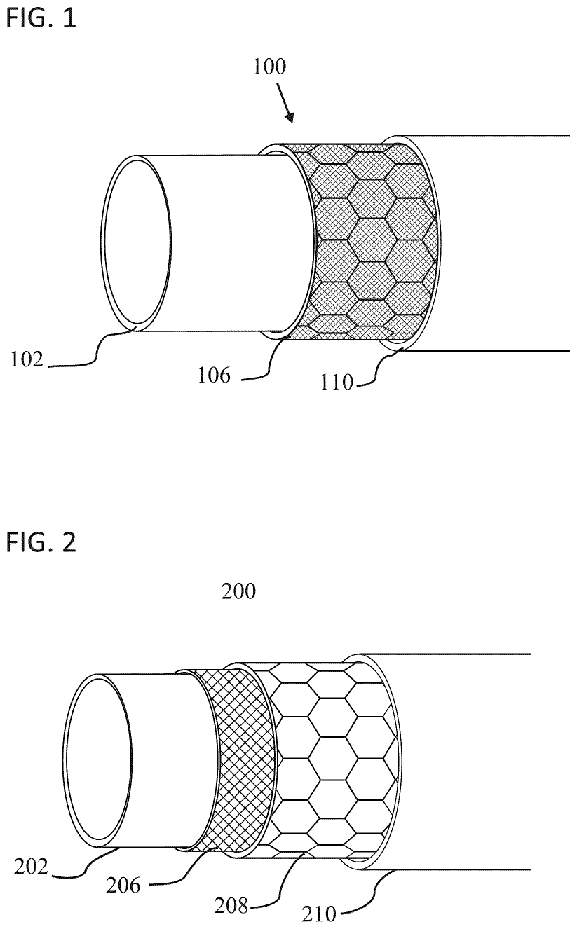

FIG. 1 shows an exemplary thermoplastic hose 100 according to the disclosure comprising, from inner to outer direction, an inner tube layer 102, a textile braid reinforcement layer 106, and a cover layer 110. The inner tube layer 102 can comprise a thermoplastic elastomer covalently bonded to the textile braid reinforcement layer 106. The textile braid reinforcement layer can be covalently bonded to the inner tube layer 102 and the outer cover layer 110. The outer cover layer 110 can comprise a thermoplastic elastomer covalently bonded to the textile braid reinforcement layer 106.

The inner tube layer 102 comprises a thermoplastic elastomer. The thermoplastic elastomer may be prepared from a composition comprising a thermoplastic polymer, copolymer, terpolymer, or blend thereof. The inner tube layer 102 may comprise a thermoplastic elastomer selected from the group consisting of a polyamide, thermoplastic polyurethane (TPU), thermoplastic polyester elastomer, thermoplastic copolyester elastomer, maleic anhydride grafted ethylene-butyl acrylate copolymer, and maleic anhydride grafted plastomer (ethylene alpha olefin copolymer).

For example, the inner tube layer 102 may be prepared from a composition comprising a TPU or polyamide and a maleic anhydride grafted ethylene-butyl acrylate copolymer or maleic anhydride grafted ethylene alpha olefin copolymer. In some examples, the inner tube layer 102 may be prepared from a composition comprising between 10-50%, or 15-40%, or 20-35% of a reactive blend comprising a maleic anhydride grafted ethylene-butyl acrylate copolymer or maleic anhydride grafted ethylene alpha olefin copolymer in a polyamide or a thermoplastic polyurethane (TPU). The polyamide may be a PA 12, PA 6/12, PA 6, or PA 6/6. In some examples the inner tube layer 102 comprises PA 12. In some examples the inner tube layer 102 comprises PA 6.

In some examples, the inner tube layer 102 is prepared from a composition comprising a thermoplastic elastomer such as polyamide or thermoplastic polyurethane, optionally further comprising a reactive blend, and optionally comprising additives such as reinforcing agents, flameproofing agents, stabilizers, processing auxiliaries, metal fibers, carbon black, graphite, metal leaf, titanium dioxide, colored pigments, and/or zinc sulfide.

The layer 106 is a reinforcement layer. The reinforcement layer 106 may comprise a treated textile braid. The treated textile braid may be prepared from reactive adhesive pretreated yarns. Examples of pretreated yarns for the reinforcement layer 106 include polyester, aramid, nylon, cotton, and rayon pretreated yarns. In some embodiments, the reinforcement layer 106 is a discontinuous layer. In some embodiments, the reinforcement layer 106 is a discontinuous layer comprising a treated polyester braid, treated aramid braid, treated nylon braid, treated cotton braid, or treated rayon braid. In some examples, the reinforcement layer 106 comprises isocyanate treated polyester yarns. In some examples, the reinforcement layer 106 comprises RFL treated polyester yarns.

The cover layer 110 may include a thermoplastic elastomer. The cover layer may comprise a thermoplastic polymer, copolymer, terpolymer, or blend thereof. The cover layer 110 may comprise a thermoplastic elastomer selected from the group consisting of a polyamide, thermoplastic polyurethane (TPU), thermoplastic polyester elastomer, thermoplastic copolyester elastomer, maleic anhydride grafted ethylene-butyl acrylate copolymer, and maleic anhydride grafted plastomer (ethylene alpha olefin copolymer).

In some examples, the outer cover layer 110 comprises a thermoplastic elastomer such as a thermoplastic polyurethane (TPU) layer or a polyamide. The outer cover layer may comprise a nonstick polyurethane. The outer cover layer may be continuous layer. The outer cover layer may be a perforated layer. The outer cover layer 110 may be a nonstick perforated polyurethane. The outer cover layer 110 may comprise a polyamide (nylon).

The outer cover layer 110 may be prepared from a composition comprising a TPU or polyamide and a maleic anhydride grafted ethylene-butyl acrylate copolymer or maleic anhydride grafted ethylene alpha olefin copolymer. In some examples, the outer cover layer 110 may be prepared from a composition comprising between 10-50%, or 15-40%, or 20-35% of a reactive blend comprising a maleic anhydride grafted ethylene-butyl acrylate copolymer or maleic anhydride grafted ethylene alpha olefin copolymer in a polyamide or thermoplastic polyurethane. The polyamide may be a PA 12, PA 6/12, PA 6, or PA 6/6. In some examples the polyamide is PA 12. In some examples the polyamide is PA 6/12. In some examples the polyamide is PA 6. In some examples the polyamide is PA 6/6.

In some embodiments, the outer cover layer 110 is prepared from a composition comprising a thermoplastic elastomer such as polyamide or thermoplastic polyurethane, optionally further comprising a reactive blend, and optionally comprising additives such as reinforcing agents, flameproofing agents, stabilizers, processing auxiliaries, metal fibers, carbon black, graphite, metal leaf, titanium dioxide, colored pigments, and/or zinc sulfide.

In some examples, the thermoplastic hose 100 of the present disclosure comprises an inner tube layer 102 comprising a polyamide (nylon), a reinforcement layer 106 comprising an isocyanate treated polyester textile braid, and an outer cover layer 110 comprising a thermoplastic polyurethane (TPU). The inner tube layer 102 and/or the cover layer 110 may further comprise a reactive blend.

The thermoplastic hose 100 may be any appropriate diameter, such as −04, −05, −06, −08, −10, −12, or −16, having inner diameter (I.D.) and outer diameter (O.D.) (nominal) as shown in Table 1.

In some examples, the thermoplastic hose 100 of the present disclosure comprises an inner tube layer 102 comprising a polyamide (nylon), a reinforcement layer 106 comprising an isocyanate treated polyester textile braid, and an outer cover layer 110 comprising a polyamide (nylon). The inner tube layer 102 and/or the cover layer 110 may further comprise a reactive blend.

FIG. 2 shows an exemplary thermoplastic hose 200 according to the disclosure comprising, from inner to outer direction, an inner tube layer 202, a first textile braid reinforcement layer 206, a second textile braid reinforcement layer 208, and an outer cover layer 210.

The inner tube layer 202 can comprise a thermoplastic elastomer. The thermoplastic elastomer may be prepared from a composition comprising a thermoplastic polymer, copolymer, terpolymer, or blend thereof. The inner tube layer 202 may comprise a thermoplastic elastomer selected from the group consisting of a polyamide, thermoplastic polyurethane (TPU), thermoplastic polyester elastomer, thermoplastic copolyester elastomer, maleic anhydride grafted ethylene-butyl acrylate copolymer, and maleic anhydride grafted plastomer (ethylene alpha olefin copolymer). For example, the inner tube layer 202 may be prepared from a composition comprising a TPU or polyamide and a maleic anhydride grafted ethylene-butyl acrylate copolymer or maleic anhydride grafted ethylene alpha olefin copolymer. The polyamide may be a PA 12, PA 6/12, PA 6, or PA 6/6. In some examples the inner tube layer 202 comprises PA 12. The inner tube layer 202 may comprise a maleic anhydride grafted elastomer.

The first and second reinforcement layers 206 and 208 each independently may comprise a treated textile braid. The treated textile braid may be prepared from resorcinol formaldehyde (RFL) or isocyanate treated yarns. Examples of suitable treated yarns for the first or second reinforcement layers 206 or 208 each independently include polyester, aramid, nylon, cotton, and rayon treated yarns. In some embodiments, each reinforcement layer 206 or 208 is independently a discontinuous layer. In some embodiments, the reinforcement layer 206 or 208 is a discontinuous layer independently comprising a treated polyester braid, treated aramid braid, treated nylon braid, treated cotton braid, or treated rayon braid. In some examples, the reinforcement layer 206 or 208 each independently comprise isocyanate treated polyester yarns. In some examples, the reinforcement layer 206 or 208 may each independently comprise RFL treated polyester yarns.

The cover layer 210 may include a thermoplastic elastomer. The cover layer may comprise a thermoplastic polymer, copolymer, terpolymer, or blend thereof. The cover layer 210 may comprise a thermoplastic elastomer selected from the group consisting of a polyamide, thermoplastic polyurethane (TPU), thermoplastic polyester elastomer, thermoplastic copolyester elastomer, maleic anhydride grafted ethylene-butyl acrylate copolymer, and maleic anhydride grafted plastomer (ethylene alpha olefin copolymer).

In some examples, the outer cover layer 210 may comprise a thermoplastic polyurethane (TPU) layer or a polyamide. The outer cover layer may comprise a nonstick polyurethane. The outer cover layer may be continuous layer. The outer cover layer may be a perforated layer. The outer cover layer 210 may be a nonstick perforated polyurethane. The outer cover layer 210 may comprise a polyamide (nylon). The outer cover layer 210 may be prepared from a composition comprising a TPU or polyamide and a maleic anhydride grafted ethylene-butyl acrylate copolymer or maleic anhydride grafted ethylene alpha olefin copolymer. The outer cover layer may be prepared from a composition comprising between 10-50%, or 15-40%, or 20-35% of a maleic anhydride grafted ethylene-butyl acrylate copolymer or maleic anhydride grafted ethylene alpha olefin copolymer in a thermoplastic polyurethane. The polyamide may be a PA 12, PA 6/12, PA 6, or PA 6/6. In some examples the polyamide is PA 12.

In some examples, the thermoplastic hose 200 of the present disclosure comprises an inner tube layer 202 comprising a polyamide (nylon), a first reinforcement layer 206 comprising an isocyanate treated polyester textile braid, a second reinforcement layer 208 comprising an isocyanate treated polyester textile braid, and an outer cover layer 210 comprising a thermoplastic polyurethane (TPU). The inner tube layer 202 may be prepared from a composition comprising between 10-50%, or 15-40%, or 20-35% of a maleic anhydride grafted ethylene-butyl acrylate copolymer or maleic anhydride grafted ethylene alpha olefin copolymer in a polyamide. The outer cover layer 210 may be prepared from a composition comprising between 10-50%, or 15-40%, or 20-35% of a maleic anhydride grafted ethylene-butyl acrylate copolymer or maleic anhydride grafted ethylene alpha olefin copolymer in a thermoplastic polyurethane (TPU).

In some examples, the thermoplastic hose 200 of the present disclosure comprises an inner tube layer 202 comprising a polyamide (nylon), a first reinforcement layer 206 comprising an isocyanate treated polyester textile braid, a second reinforcement layer 208 comprising an isocyanate treated polyester textile braid, and an outer cover layer 210 comprising a polyamide (nylon). The inner tube layer 202 may be prepared from a composition comprising between 10-50%, or 15-40%, or 20-35% of a maleic anhydride grafted ethylene-butyl acrylate copolymer or maleic anhydride grafted ethylene alpha olefin copolymer in a polyamide.

The outer cover layer 210 may be prepared from a composition comprising between 10-50%, or 15-40%, or 20-35% of a maleic anhydride grafted ethylene-butyl acrylate copolymer or maleic anhydride grafted ethylene alpha olefin copolymer in a polyamide. The polyamide may be a PA 12, PA 6/12, PA 6, or PA 6/6. In some examples the polyamide is PA 12.

The outer cover layer 210 may comprise a thermoplastic polyurethane (TPU). The outer cover layer may comprise a nonstick polyurethane. The outer cover layer may be continuous layer. The outer cover layer may be a perforated layer. The outer cover layer 210 may be a nonstick perforated polyurethane. The outer cover layer 210 may be a polyamide (nylon) layer.

The thermoplastic hose 200 can be any appropriate diameter, such as −06 (ID. 9.7 mm; O.D. 17.0 mm), −08 (ID. 13.0 mm; O.D. 21.6 mm), or −10 (ID. 16.2 mm; O.D. 27.0 mm), and the like.

### Thermoplastic Elastomers

The thermoplastic hose may contain one or more thermoplastic layers. The inner tube layer may comprise a thermoplastic elastomer. The outer cover layer may comprise a thermoplastic elastomer. The thermoplastic elastomer can be selected from the group consisting of a polyamide (nylon), thermoplastic polyurethane (TPU), thermoplastic polyester elastomer, and thermoplastic copolyester elastomer. The thermoplastic layer may be prepared from a composition comprising a thermoplastic polymer, copolymer, terpolymer, or blend. For example, the thermoplastic elastomer may be selected from the group consisting of a polyamide, thermoplastic polyurethane (TPU), thermoplastic polyester elastomer, thermoplastic copolyester elastomer, maleic anhydride grafted ethylene-butyl acrylate copolymer, and maleic anhydride grafted plastomer (ethylene alpha olefin copolymer).

The thermoplastic polyurethane ((TPU) may be a thermoplastic polyether-based polyurethane, for example, commercially available as ELASTOLLAN® 1598A from BASF. The TPU may be a thermoplastic polyether-based polyurethane available as ELASTOLLAN® 1195A from BASF.

Examples of suitable polyamides (nylon) may include PA 6 (polyamide 6; nylon 6), PA 6/6 (polyamide 6,6; nylon 6,6), PA 11 (polyamide 11, nylon 11), PA 12 (polyamide 12; nylon 12), PA 6/12 (polyamide 612; nylon 6,12), and PA 610 (polyamide 610; nylon 6,10). In some embodiments, suitable nylon polyamides may include PA 6, PA 6,6, PA 12 and PA 11. In still other embodiments, suitable nylon polyamides include PA 12, PA 6 and PA 6,6. In some examples, the polyamide may be PA 12. Polyamides are commercially available from, for example, Arkema.

An elastomeric composition comprising a maleic anhydride grafted elastomer is called a reactive blend.

The thermoplastic elastomer may comprise a maleic anhydride grafted elastomer. The maleic anhydride grafted elastomer may be commercially available. The maleic anhydride grafted elastomer may be selected from the group consisting of maleic anhydride grafted ethylene-butyl acrylate copolymer, and maleic anhydride grafted plastomer (ethylene alpha olefin copolymer). Ethylene butyl acrylate (EBA) is a copolymer comprising ethylene and butyl acrylate that may be prepared by high pressure radical polymerization. The butyl acrylate may be n-butyl acrylate. Maleic anhydride grafted EBA is commercially available from, for example, Industrie Polieco-MPB Srl., Italy. Due to the butyl acrylate content it can be used for applications where softness, flexibility and polarity are required. For example, COESIVE® 40 is a maleic anhydride grafted ethylene-butyl acrylate copolymer comprising about 17% butyl acrylate content.

The maleic anhydride grafted plastomer (ethylene alpha olefin copolymer) may be commercially available as COESIVE® C50 from Industrie Polieco M.P.B. Srl, Italy. The maleic anhydride grafted ethylene-butyl acrylate copolymer is commercially available as COESIVE® EB40 from Industrie Polieco M.P.B. Srl, Italy. In some examples, the reactive blend comprises a composition comprising between 10-50%, or 15-40%, or 20-35% of a maleic anhydride grafted ethylene-butyl acrylate copolymer or maleic anhydride grafted ethylene alpha olefin copolymer in a polyamide or a TPU.

In some examples, the outer cover layer is prepared from a composition comprising between 10-50% maleic anhydride grafted ethylene-butyl acrylate copolymer (EB40) or maleic anhydride grafted ethylene alpha olefin copolymer (C50) in a polyamide or a TPU.

In some examples, the reactive blend comprises between 10-50% maleic anhydride grafted ethylene-butyl acrylate copolymer in a polyamide. In some examples, the reactive blend comprises between 10-50% maleic anhydride grafted ethylene alpha olefin copolymer in a polyamide.

In some examples, the inner tube layer is prepared from a composition comprising between 10-50% maleic anhydride grafted ethylene-butyl acrylate copolymer (EB40) or maleic anhydride grafted ethylene alpha olefin copolymer (C50) in a polyamide or a TPU. The inner tube layer may comprise one or more layers. In some examples, the inner tube layer comprises a polyamide. In some examples, the inner tube layer may be polyester lined. In some examples, the inner tube layer 102 comprises a TPU.

### Isocyanates

Isocyanates are a family of low molecular weight, highly reactive compounds containing an isocyanate moiety (—N═C═O). Isocyanates are used in the manufacture of a variety of materials such as adhesives, rigid foams, fibers, coatings such as paints and varnishes, and elastomers. Isocyanates are irritants to mucous membranes, eyes, gastrointestinal tracts, and respiratory tracts. Isocyanates may cause dermal inflammation. Respiratory and dermal exposures may lead to sensitization. Preventing exposure to isocyanates may help eliminate potential health hazards. Commonly employed isocyanates may include methylene bis(phenyl isocyanate)(MDI), toluene diisocyanate (TDI), hexamethylene diisocyanate (HDI), naphthalene diisocyanate (NDI), methylene bis-cyclohexyl isocyanate (HMDI) (hydrogenated MDI), and isophorone diisocyanate (IPDI). Polyisocyanates may include HDI biuret and HDI isocyanate.

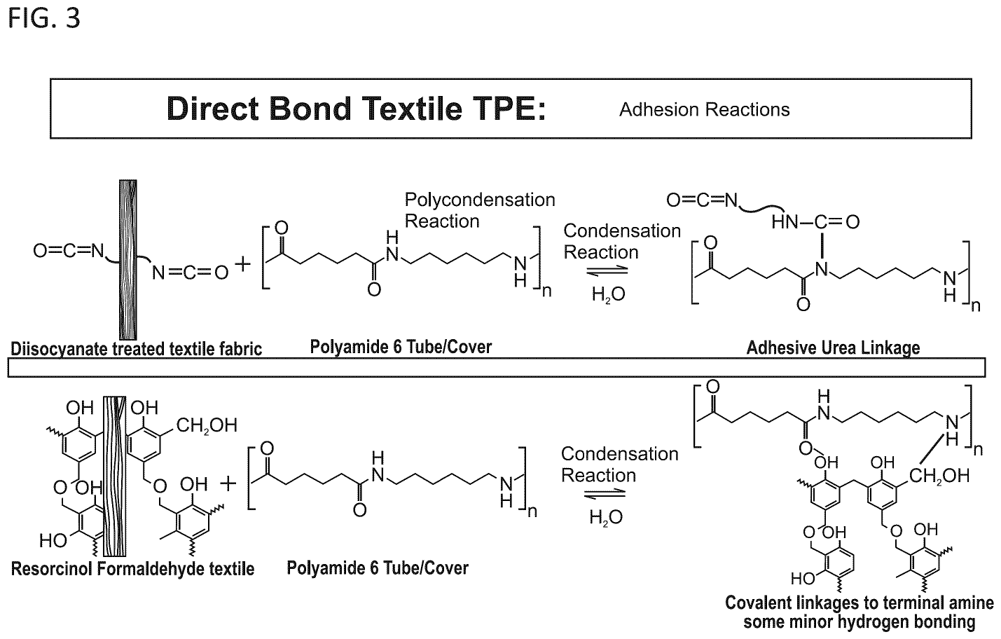

Direct bond textile TPE adhesion reactions are illustrated in FIG. 3.

The isocyanate moiety —N═C═O is chemically reactive with an amide moiety —C(═O)NH— to form an adhesive urea linkage —C(═O)—NC(═O)—NH—.

### RFLs

Resorcinol-formaldehyde (RF) resins are synthetic thermosetting resin systems obtained from poly condensation of formaldehyde with resorcinol (1,3-dihydroxybenzene). Resorcinol-formaldehyde latex (RFL) adhesives can be used to treat textiles to make them chemically bondable to rubber. RFLs are chemically combined to make strong, heat resistant, flexible adhesive that is suited for rubber to fabric textile bonding. The rubber latex can be, for example, natural rubber latex, styrene butadiene vinylpyridine (terpolymer) (SBVPL), or neoprene latex.

Resorcinol may also be co-polymerized with phenol and formaldehyde resins (PRF resins). Resorcinol resins form very durable and strong bonds with good humidity, water, and corrosion resistance. RF and PRF resins may be used as bonding agents in vulcanized rubber products to enhance adhesion between rubber and plastic layers. RF resin can be used to achieve good adhesion to an organic fiber substrate such as, e.g., polyester, rayon, or nylon.

### Methods of Making

The thermoplastic hose may be prepared in an “in line” process, for example, the inner plastic tube may be extruded, and then run through a braider machine loaded with spindles of the treated polyester yarn. The braiding process will wind the yarn around the hose tube applying the necessary intimate contact between textile and thermoplastic. The process may be performed in a heated (>100° C.) state where the reaction between either the RFL or isocyanate treated yarns and the thermoplastic will occur thereby generating the covalent interaction.

The cover to braid adhesion will occur in a similar fashion with the outer jacket being extruded over the top of the fiber at an elevated temperature. In some examples, suitable thermoplastics include thermoplastic polyurethane (TPU), polyamide 6, polyamide 12, as well as reactive blends incorporating maleic anhydride chemistry into the polymer matrix.

In some examples, the reactive blend comprises a composition comprising between 10-50%, or 15-40%, or 20-35% of a maleic anhydride grafted ethylene-butyl acrylate copolymer or maleic anhydride grafted ethylene alpha olefin copolymer in a polyamide. In some examples, the reactive blend comprises a composition comprising between 10-50%, or 15-40%, or 20-35% of a maleic anhydride grafted ethylene-butyl acrylate copolymer or maleic anhydride grafted ethylene alpha olefin copolymer in a thermoplastic polyurethane (TPU).

### Tests

A strip adhesion test between layers may be conducted in accordance with ASTM D 413-81. This test measures the adhesion strength between various layers, for example, between a thermoplastic layer and a reinforcement layer, or between two thermoplastic layers having an intervening reinforcement layer. Specimen Type B—90° peel was used. The sample is prepared using thermoplastic elastomer (e.g., polyamide 12) injection molded samples that were 4″ long, 1″ wide, and 0.075″ thick. The PA 12 samples may be laid on top of reinforcement samples that are 4″ long, 1″ wide and 0.09″ thick, on a standard press cure. The samples are vulcanized for 45 minutes at 320° F. Twenty-four hours after vulcanization, the samples are tested on a calibrated Instron 5965 (according to ASTM D413 Type B (90° peel)) using a 5 KN load cell at a rate of 2″/min. Tensile strength and percent elongation may be tested in accordance with ASTM D412 standard test methods. Standard ASTM samples may be tested on a calibrated Instron 5965 using a 5 KN load cell at a rate of 20″/min.

The hardness of the elastomeric material may be tested in a Shore A hardness test in accordance with ASTM D 2240-95. The hardness may be tested using a calibrated Instron automatic Durometer tester.

The compression set of the elastomeric material may be tested in accordance with ASTM D 395-89. The sample may be prepared as follows. Following cure, the material may be formed into 0.49″ thick by 1.14″ diameter buttons. Then the buttons were compressed by 25% into a C Set fixture. After curing, the samples are exposed at −40° C. for 24 hours and samples were removed and measured at specified time increments. The overall compression set may be assessed on a sample that is allowed to run 24 hours and then rebound at room temperature outside of the C Set fixture prior to the final measurement.

Permeation of test hose and comparative hose may be tested in accordance with SAE J2064. Samples are stabilized for 24 hours at 23° C.±2° C. before testing and checked to ensure specified charge and identify charge loss.

Pressure testing, including impulse testing and burst, may be performed according to SAE J343 test, and test procedures for SAE 100R series hydraulic hoses. The maximum allowable “working pressure” assigned to a hose product may be based on laboratory conditions a straight length and at 20° C.

### Hose Dimensions

In some embodiments, the thermoplastic hoses according to the present disclosure may exhibit the following dimensions and properties as shown in Table 1.

TABLE 1
Thermoplastic Hose Dimensions and Properties

| | |
|---|---|
| Hose I.D. | Hose O.D. (nominal) |

| size | mm | in | mm | in |
|---|---|---|---|---|
| −04 | 6.4 | 0.25 | 12.5 | 0.49 |
| −05 | 7.9 | 0.31 | 14.6 | 0.57 |
| −06 | 9.5 | 0.38 | 16.5 | 0.65 |
| −08 | 12.7 | 0.50 | 20.8 | 0.82 |
| −10 | 16.0 | 0.63 | 23.6 | 0.93 |
| −12 | 19.0 | 0.75 | 26.4 | 1.04 |
| −16 | 25.4 | 1.00 | 33.7 | 1.33 |

### EXAMPLES

### Example 1. Adhesion Strength of Thermoplastic Elastomer to Textile Braid Reinforcement

Standard and Test samples of textile reinforcement comprising isocyanate polyester yarns were tested for adhesion strength Maximum load to various elastomers by ASTM D413 Type B 90 deg peel. Various non-pretreated and pre-treated isocyanate polyester yarns were employed to prepare a textile braid reinforcement layer bonded to a thermoplastic elastomer layer. Elastomer samples included thermoplastic elastomers polyamide (PA12), polyurethane (1195A), maleic anhydride grafted plastomer (ethylene alpha olefin copolymer) (C50), and maleic anhydride grafted ethylene-butyl acrylate copolymer (EB40).

Pretreated isocyanate adhesive treated polyester yarns were obtained commercially from Beaver Manufacturing Company, Mansfield, Georgia. Test yarns included Beaverloc® 102 isocyanate treated fibers designed for adhesion to EPDM, CPE, and CSM; Beaverloc® 108 isocyanate treated adhesive activated polyester designed for adhesion to various rubbers including for adhesion to EPDM, CPE, and CSM; Beaverloc® 304 isocyanate treated fibers designed for butyl rubber adhesion; and Beaverloc® 140 treated fibers designed for adhesion to various rubber types, e.g., NBR, CR, ACM/AEM.

Standard and Test samples of isocyanate polyester yarns reinforcement layers were tested were tested for adhesion maximum load to various elastomers by ASTM D413 Type B 90 deg C. peel. Results are shown in Table 2. Final result is in lbf units.

TABLE 2
Polyester Yarn-Elastomer Adhesion Strength Maximum Load (lbf)

| | | | Test 1: | Test 2: | | | |
|---|---|---|---|---|---|---|---|
| | Standard | Standard | 102 | 102 | Test 3: 108 | Test 4: 304 | Test 5: 140 |
| | Isocyanate | Isocyanate | polyester | polyester | polyester | polyester | polyester |
| | Treatment | Treatment | T-SF2 | T174S | T-161ST2 | T-161 ST2 | T-174S |
| Elastomer | 1 | 2 | 1.5Z | 1.5Z | 1.5Z | 1.5Z | 1.5Z |
| EB40 | 9.445 | 8.75 | 19.48 | 16.105 | 17.325 | 17.39 | 15.605 |
| C50 | 5.225 | 4.08 | 12.055 | 15.855 | 13.535 | 18.45 | 9.835 |
| 1195A | 5.645 | 1.93 | 4.21 | 2.615 | 6.75 | 5.545 | 7.025 |
| PA12 | 1.355 | 2.555 | 8.34 | 11.635 | 12.4 | 13.035 | 11.49 |

Results: Samples comprising thermoplastic elastomers polyamide (PA12), maleic anhydride grafted plastomer (ethylene alpha olefin copolymer)(C50), and maleic anhydride grafted ethylene-butyl acrylate copolymer (EB40) each exhibited improved adhesion strength to braid reinforcement layer comprising isocyanate pre-treated polyester yarns when compared to standard isocyanate treatments, as shown in Table 2. Thermoplastic polyurethane (1195A) exhibited improved adhesion to pre-treated test fibers 108 polyester T-161ST2 and 140 polyester T-174S compared to standard isocyanate treatment. The EB40 reactive blend exhibited best adhesion with all fibers. The PA12 polyamide exhibited substantially improved adhesion to textile braid reinforcement layer comprising isocyanate pre-treated polyester yarns when compared to standard isocyanate treatments using untreated polyester yarns.

### Clauses

Clause 1. A thermoplastic hose comprising a multiplicity of layers comprising:
a first textile braid reinforcement layer covalently bound to
an inner tube layer comprising a first thermoplastic elastomer, and
an outer cover layer comprising a second thermoplastic elastomer.

Clause 2. The thermoplastic hose according to clause 1, wherein the first textile braid reinforcement layer comprises a pretreated yarn selected from the group consisting of polyester, aramid, nylon, cotton, and rayon pretreated yarns.

Clause 3. The thermoplastic hose according to clause 2, wherein the pretreated yarn comprises a reactive adhesive coating capable of forming covalent bonds to the first thermoplastic elastomer.

Clause 4. The thermoplastic hose according to clause 3, wherein the pretreated yarn comprises an immobilized isocyanate, resorcinol formaldehyde (RF), or phenol resorcinol formaldehyde (PRF) reactive adhesive coating, optionally wherein the pretreated yarn is an isocyanate pretreated polyester yarn.

Clause 5. The thermoplastic hose according to any one of clauses 1 to 4, wherein the inner tube layer comprises a first thermoplastic elastomer selected from the group consisting of polyamide, thermoplastic polyurethane, thermoplastic polyester elastomer, copolyester, acrylic copolymer, polyolefin blend, and polyolefin alloy, optionally wherein the first thermoplastic elastomer is a polyamide or a thermoplastic polyurethane.

Clause 6. The thermoplastic hose according to clause 5, wherein the inner tube layer further comprises a maleic anhydride grafted copolymer.

Clause 7. The thermoplastic hose according to clause 6, wherein the maleic anhydride grafted copolymer is selected from the group consisting of maleic anhydride grafted ethylene-butyl acrylate copolymer and maleic anhydride grafted plastomer (ethylene alpha olefin copolymer).

Clause 8. The thermoplastic hose according to any one of clauses 1 to 7, wherein the inner tube layer comprises 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomers in the inner tube layer.

Clause 9. The thermoplastic hose according to any one of clauses 1 to 8, wherein the outer cover layer comprises a second thermoplastic elastomer selected from the group consisting of polyamide, thermoplastic polyurethane, thermoplastic polyester elastomer, copolyester, acrylic copolymer, polyolefin blend, and polyolefin alloy, optionally wherein the second thermoplastic elastomer is a polyamide or a thermoplastic polyurethane.

Clause 10. The thermoplastic hose according to clause 9, wherein the outer cover layer comprises a maleic anhydride grafted thermoplastic copolymer.

Clause 11. The thermoplastic hose according to clause 10, wherein the maleic anhydride grafted copolymer is selected from the group consisting of maleic anhydride grafted ethylene-butyl acrylate copolymer and maleic anhydride grafted plastomer (ethylene alpha olefin copolymer).

Clause 12. The thermoplastic hose according to any one of clauses 1 to 11, wherein the outer cover layer comprises 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomers in the outer cover layer.

Clause 13. The thermoplastic hose according to any one of clauses 1 to 12, wherein the first thermoplastic elastomer and the second thermoplastic elastomer are different.

Clause 14. The thermoplastic hose according to any one of clauses 1 to 13, wherein the first textile braid reinforcement layer is covalently bound to the outer cover layer.

Clause 15. The thermoplastic hose according to any one of clauses 1 to 14, further comprising a second textile braid layer covalently bound to the outer cover layer.

Clause 16. The thermoplastic hose according to any one of clauses 1 to 15, comprising from the interior surface to the exterior surface of the hose:
an inner tube layer comprising a first thermoplastic elastomer covalently bound to a first textile braid reinforcement layer; and
a second textile braid layer covalently bound to
an outer cover layer comprising a second thermoplastic elastomer.

Clause 17. The thermoplastic hose according to any one of clauses 1 to 16, wherein the adhesive strength between the inner tube layer and the first textile braid reinforcement layer is at least 8 lbf, at least 10 lbf, or at least 15 lbf, when tested according to ASTM D413 Type B, 90° peel.

Clause 18. A method of making a thermoplastic hose according to any one of clauses 1 to 16, comprising:
extruding a first thermoplastic elastomer composition over a mandrel to form the inner tube layer;
braiding a first pretreated yarn over the inner tube layer to form a first textile braid reinforcement layer;
heating the first textile braid reinforcement layer to a temperature >100 C to form a covalent bond between the pretreated yarn and the first thermoplastic elastomer to form a covalently bonded first textile braid reinforcement layer; and
extruding a second thermoplastic elastomer composition over the covalently bonded first textile braid reinforcement layer to form the cover layer, heating to a temperature >100° C., and cooling to form the thermoplastic hose.

Clause 19. The method according to clause 18, further comprising:
expelling the hose from the mandrel.

Clause 20. The method according to clause 18 or 19, further comprising:
braiding a second pretreated yarn over the reinforced inner tube layer prior to the second extruding step.

Clause 21. The method according to any one of clauses 18 to 20, wherein the first pretreated yarn comprises a polyester, aramid, nylon, cotton, or rayon yarn pretreated with a reactive adhesive coating capable of forming covalent bonds to a first thermoplastic elastomer in the first thermoplastic elastomer composition.

Clause 22. The method according to clause 21, wherein the first pretreated yarn comprises an immobilized isocyanate, resorcinol formaldehyde (RF), or phenol resorcinol formaldehyde (PRF) reactive adhesive coating.

Clause 23. The method according to any one of clauses 18 to 22, wherein the first thermoplastic elastomer composition comprises a first thermoplastic elastomer selected from the group consisting of polyamide, thermoplastic polyurethane, thermoplastic polyester elastomer, copolyester, acrylic copolymer, polyolefin blend, and polyolefin alloy.

Clause 24. The method according to clause 23, wherein the first thermoplastic elastomer composition comprises a maleic anhydride grafted thermoplastic copolymer.

Clause 25. The method according to clause 24, wherein the maleic anhydride grafted copolymer is selected from the group consisting of maleic anhydride grafted ethylene-butyl acrylate copolymer and maleic anhydride grafted plastomer (ethylene alpha olefin copolymer).

Clause 26. The method according to any one of clauses 18 to 25, wherein the first thermoplastic elastomer composition comprises 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomers in the composition.

Clause 27. The method according to any one of clauses 18 to 26, wherein the second thermoplastic elastomer composition comprises a second thermoplastic elastomer selected from the group consisting of polyamide, thermoplastic polyurethane, thermoplastic polyester elastomer, copolyester, acrylic copolymer, polyolefin blend, and polyolefin alloy.

Clause 28. The method according to clause 27, wherein the second thermoplastic elastomer composition comprises a maleic anhydride grafted copolymer.

Clause 29. The method according to clause 28, wherein the maleic anhydride grafted copolymer is selected from the group consisting of maleic anhydride grafted ethylene-butyl acrylate copolymer and maleic anhydride grafted plastomer (ethylene alpha olefin copolymer).

Clause 30. The method according to any one of clauses 18 to 29, wherein the second thermoplastic elastomer composition comprises 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomers in the composition.

Clause 31. The method according to any one of clauses 18 to 30, wherein the first thermoplastic elastomer and the second thermoplastic elastomer are different.

Clause 32. The method according to any one of clauses 18 to 31, wherein the first textile braid reinforcement layer is covalently bound to the outer cover layer.

Clause 33. The method according to clause 20, wherein the second textile braid reinforcement layer is covalently bound to the outer cover layer.

Clause 34. The method according to any one of clauses 18 to 33, wherein the thermoplastic hose comprises in the direction from the interior to the exterior surface of the hose:
an inner tube layer comprising a first thermoplastic elastomer covalently bound to a first textile braid reinforcement layer; and
a second textile braid reinforcement layer covalently bound to the outer cover layer comprising a second thermoplastic elastomer.

Clause 35. The method according to any one of clauses 18 to 34, wherein the adhesive strength between the inner tube layer and the first textile braid layer of the thermoplastic hose is at least 8 lbf, at least 10 lbf, or at least 15 lbf, when tested according to ASTM D413 Type B, 90° peel.

1. A thermoplastic hose comprising a multiplicity of layers comprising:
a first textile braid reinforcement layer covalently bound to
an inner tube layer comprising a first thermoplastic elastomer, and
an outer cover layer comprising a second thermoplastic elastomer,
wherein the inner tube layer comprises a first thermoplastic elastomer selected from the group consisting of polyamide, thermoplastic polyurethane, thermoplastic polyester elastomer, copolyester, acrylic copolymer, polyolefin blend, and polyolefin alloy.

2. The thermoplastic hose according to claim 1, wherein the first textile braid reinforcement layer comprises a pretreated yarn selected from the group consisting of polyester, aramid, nylon, cotton, and rayon pretreated yarns.

3. The thermoplastic hose according to claim 2, wherein the pretreated yarn comprises a reactive adhesive coating capable of forming covalent bonds to the first thermoplastic elastomer.

4. The thermoplastic hose according to claim 3, wherein the pretreated yarn comprises an immobilized isocyanate, resorcinol formaldehyde (RF), or phenol resorcinol formaldehyde (PRF) reactive adhesive coating, optionally wherein the pretreated yarn is an isocyanate pretreated polyester yarn.

5. The thermoplastic hose according to claim 1, wherein the first thermoplastic elastomer is a polyamide or a thermoplastic polyurethane.

6. The thermoplastic hose according to claim 1, wherein the inner tube layer further comprises a maleic anhydride grafted copolymer.

7. The thermoplastic hose according to claim 6, wherein the maleic anhydride grafted copolymer is selected from the group consisting of maleic anhydride grafted ethylene-butyl acrylate copolymer and maleic anhydride grafted plastomer (ethylene alpha olefin copolymer).

8. The thermoplastic hose according to claim 7, wherein the inner tube layer comprises 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomers in the inner tube layer.

9. The thermoplastic hose according to claim 1, wherein the outer cover layer comprises a second thermoplastic elastomer selected from the group consisting of polyamide, thermoplastic polyurethane, thermoplastic polyester elastomer, copolyester, acrylic copolymer, polyolefin blend, and polyolefin alloy, optionally wherein the second thermoplastic elastomer is a polyamide or a thermoplastic polyurethane.

10. The thermoplastic hose according to claim 9, wherein the outer cover layer comprises a maleic anhydride grafted thermoplastic copolymer.

11. The thermoplastic hose according to claim 10, wherein the maleic anhydride grafted copolymer is selected from the group consisting of maleic anhydride grafted ethylene-butyl acrylate copolymer and maleic anhydride grafted plastomer (ethylene alpha olefin copolymer).

12. The thermoplastic hose according to claim 11, wherein the outer cover layer comprises 10-50 wt %, or 15-40 wt %, or 20-35 wt % of a maleic anhydride grafted ethylene-butyl acrylate copolymer or maleic anhydride grafted ethylene alpha olefin copolymer in a thermoplastic polyurethane or a polyamide compared to total weight of thermoplastic elastomers in the outer cover layer.

13. The thermoplastic hose according to claim 1, wherein the first thermoplastic elastomer and the second thermoplastic elastomer are different.

14. The thermoplastic hose according to claim 1, wherein the first textile braid reinforcement layer is covalently bound to the outer cover layer.

15. The thermoplastic hose according to claim 1, further comprising a second textile braid layer covalently bound to the outer cover layer.

16. The thermoplastic hose according to claim 15, comprising in the direction from the interior surface to the exterior surface of the hose:
an inner tube layer comprising a first thermoplastic elastomer covalently bound to a first textile braid reinforcement layer; and
a second textile braid layer covalently bound to
an outer cover layer comprising a second thermoplastic elastomer.

17. The thermoplastic hose according to claim 1, wherein the adhesive strength between the inner tube layer and the first textile braid reinforcement layer is at least 8 lbf, at least 10 lbf, or at least 15 lbf, when tested according to ASTM D413 Type B, 90° peel.

18. A method of making a thermoplastic hose according to claim 1, comprising:
extruding a first thermoplastic elastomer composition over a mandrel to form the inner tube layer;
braiding a first pretreated yarn over the inner tube layer to form a first textile braid reinforcement layer;
heating the first textile braid reinforcement layer to a temperature >100° C. to form a covalent bond between the pretreated yarn and the first thermoplastic elastomer to form a covalently bonded first textile braid reinforcement layer; and
extruding a second thermoplastic elastomer composition over the covalently bonded first textile braid reinforcement layer to form the cover layer, heating to a temperature >100° C., and cooling to form the thermoplastic hose.

19. The method according to claim 18, further comprising:
expelling the hose from the mandrel.

20. The method according to claim 18, further comprising:
braiding a second pretreated yarn over the reinforced inner tube layer prior to the second extruding step.

21-35. (canceled)
